(19) United States
(12) Patent Application Publication
(10) Pub. No.: US 2025/0087107 A1
(43) Pub. Date: Mar. 13, 2025

(54) SYSTEM AND METHOD OF TRANSITIONING BETWEEN VIRTUAL REALITY AND MIXED REALITY

(71) Applicant: Eddie Martin, Spring, TX (US)

(72) Inventor: Eddie Martin, Spring, TX (US)

(21) Appl. No.: 18/825,603

(22) Filed: Sep. 5, 2024

Related U.S. Application Data
(60) Provisional application No. 63/582,117, filed on Sep. 12, 2023.

(51) Int. Cl. G09B 9/05; G06T 19/00

(52) U.S. Cl. CPC G09B 9/05; G06T 19/006

(57) ABSTRACT

A method that includes displaying, via a virtual reality (“VR”) headset, a portion of an immersive program in a VR simulation setting; wherein the immersive program comprises visuals of objects; and wherein the VR simulation setting comprises an immersive 3D environment in which the visuals of objects appear in 3D. The method also includes receiving a first indication that the VR simulation setting should be changed from the VR simulation setting to a mixed reality (“MR”) simulation setting; and displaying, in response to receipt of the first indication, the portion of the immersive program in MR setting. The VR headset is positioned in a physical world, the MR simulation comprises displaying, over a view of the physical world, a virtual overlay; and the virtual overlay comprises a virtual screen displaying the visuals of objects.

### CROSS-REFERENCE TO RELATED APPLICATION

This application claims the benefit of the filing date of, and priority to, U.S. Application No. 63/582, 117, filed Sep. 12, 2023, the entire disclosure of which is hereby incorporated herein by reference.

### TECHNICAL FIELD

The present disclosure relates generally to simulation programs and, more specifically, to training programs for vehicles using virtual reality.

### BACKGROUND

Many jobs or duties require a person to safely operate, drive, or pilot a self-propelled vehicle. The right to operate these vehicles require the operator to become trained and demonstrably proficient in that operation, with certification or licensure granted from a governing body as a prerequisite to ongoing legal operation. An automobile driver's license, forklift operator's license, or commercial pilot's license are three of many examples.

The most practical training in vehicle operation is done using the vehicle itself, operated in the actual environment where the vehicle will be used, with a qualified instructor monitoring and training the needed skills to the new operator. This “Live Training” places the trainee, instructor, vehicle, and frequently, the public at risk. The trainee, while learning to operate the vehicle, lacks sufficient skills or judgment to ensure their safety. The burden of safety falls to the instructor. Despite the risks, this is the most widely used training approach.

To moderate risk, particularly when risks are very high, vehicle simulators can be used, such as cockpit simulator for flight training. Simulators are dedicated training devices that attempt to replicate live operation of the vehicle through artificial means. Simulators are typically expensive, well-provisioned and powerful computer-based devices running simulation and training software. They are equipped with specialized input devices to simulate vehicle operation, for instance, a steering wheel, rudder, and/or pedals, and specialized output devices to present the simulated training environment, with extensive graphics, sound, and motion capabilities, using computer monitors, speakers, and motors/actuators to simulate the environment for the trainee. Some simulators are more expensive than the vehicle they simulate.

This “Simulator Training” provides a much safer and more comfortable environment for training, particularly training that involves high-risk scenarios. This capability, however, comes with substantial initial and ongoing costs, making it impractical for many forms of training. Simulators are also delicate, complex computer devices, requiring significant maintenance and a clean, cool operating environment, difficult to relocate. Thus, trainees must travel to where the limited number of simulators are located, creating significant travel expense and simulator scheduling challenges. Finally, there are significant limitations in the quality of the simulation, such as the inability for two dimensional monitors to accurately represent three-dimensional space, limiting depth perception, and lacking a 360 degree view for training situational awareness.

As an enhancement to simulators, in some cases virtual reality (VR) headsets have been employed to replace the larger, non-wearable monitors and speakers. Generally, VR is the ability to fully immerse a user into a computer-generated environment via multisensory presentation with the goal of the user to feel physically present in that simulated environment. VR headsets use motion-tracking and three-dimensional displays with software that adjusts the user's view in real time to give the user the perception of a full 360 degree field of view, with associated spatial sound. Generally, VR Training offers the advantages of improved realism and training accuracy, but the conventional VR training systems are associated with drawbacks.

An example drawback of conventional VR training systems is that many trainees (estimates range up to 30%) find that they cannot physically tolerate VR, in particular the simulated motion. The resulting symptoms, sometimes called cybersickness, include disorientation, sweating, excess saliva production, and nausea. Research indicates these symptoms result when the optical signals received by a VR user do not align with the motion-sensing cues to the user's vestibular system. With motion-oriented VR simulation, these conflicting signals cause symptoms to get progressively worse until many users must capitulate and terminate the session. Much research has been done over many years to try to find ways to mitigate these symptoms in VR, with limited success. As a result, many potential VR trainees are physically unable to complete VR training and must resort to other training methods. For an employer with large-scale training needs, supporting multiple training approaches is inefficient and highly undesirable.

As such, a simulation training system that provides the improved realism and training accuracy advantages of VR while preventing cybersickness in an easily transportable form is desirable.

### BRIEF DESCRIPTION OF THE DRAWINGS

FIG. 1 is a diagrammatic illustration of a training system, according to an example embodiment, the training system including a computer, a VR headset, and a training rig.

FIG. 2 is a diagrammatic illustration of the computer of FIG. 1, according to an example embodiment.

FIG. 3 is a flow chart illustrating a method of operating the system of FIG. 1, according to an example embodiment.

FIG. 4 is an illustration of a portion of a training program displayed in a VR simulation setting, according to an example embodiment.

FIG. 5 is an illustration of the portion of the training program displayed in FIG. 4 in a Mixed Reality (“MR”) simulation setting, according to an example embodiment.

FIG. 6 is a side view of a user of the system of FIG. 1 in the physical world showing an overlay that is viewable by the user, according to an example embodiment.

FIG. 7 is a perspective view of the user of the system of FIG. 1 in the physical showing an overlay that is viewable by the user, according to an example embodiment.

FIG. 8 is another perspective view of the user of the system of FIG. 1 in the physical showing an overlay that is viewable by the user, according to an example embodiment.

FIG. 9 is an illustration of an overlay including a virtual screen that is a bent virtual screen, according to an example embodiment.

FIG. 10 is another perspective view of the user of the system of FIG. 1 in the physical showing an overlay that is viewable by the user, according to an example embodiment.

FIG. 11 is an illustration of an overlay including a display of a virtual hand, according to an example embodiment.

FIG. 12 is a diagrammatic illustration of a node for implementing one or more example embodiments of the present disclosure, according to one or more aspects of the present disclosure.

### DETAILED DESCRIPTION

The present disclosure addresses problems associated with conventional training programs, including conventional VR training systems, by employing another multisensory technology, Mixed Reality (“MR”). MR is similar to VR, but MR involves blending actual elements from the physical world and virtual elements into a combined environment for presentation to the MR user. This is often done via a VR/MR headset that is like a VR headset but also equipped with cameras to video-capture the MR user's view of the physical world or live environment. In MR, the video stream from these cameras is then re-displayed to the user vie the display system in the headset, allowing the user to see their current environment. At the same time, software-generated virtual elements can be added for the user's benefit or entertainment. MR headsets also work for VR: by foregoing the display of camera input and displaying only computer-generated images and sound to the user, the MR headset can be used for VR. As such and for the purposes of this disclosure, the term “VR headset” is equivalent to the term “MR headset” and/or “VR/MR headset.”

The system and method described herein combines MR with VR to resolve the limitations and problems described above. With the described system and method, the MR user, while running a VR motion simulation for any purpose, such as for vehicular training, is given the ability to switch quickly and easily to a different representation of the same computer-generated environment between the highly immersive and realistic VR 3D/360° representation, and an alternate 2D Mixed Reality mode. In some embodiments, the system and method is referred to as XDriVR™.

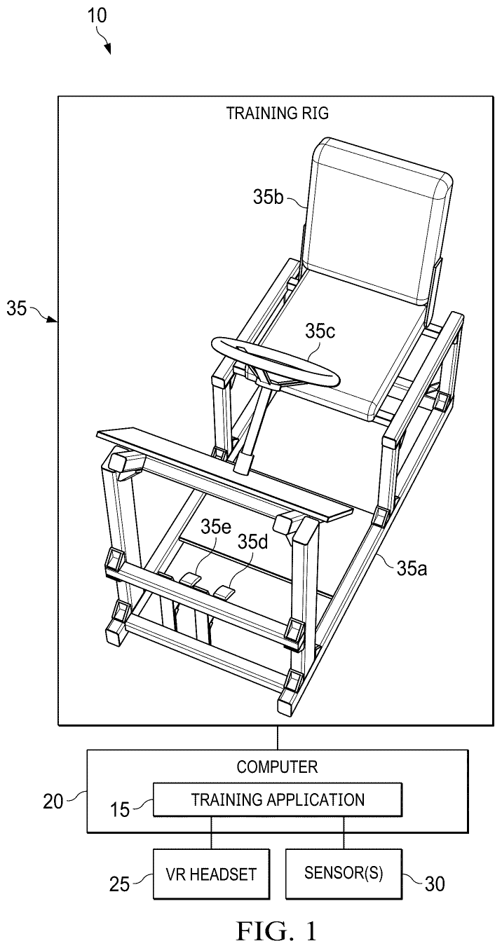

FIG. 1 provides an illustration of an example training system 10 that transitions between mixed reality and virtual reality. Generally, the training system is configured to train a user on the use of a piece of equipment, such as a vehicle. In an example embodiment and as illustrated in FIG. 1, the system 10 generally includes a training application 15 stored on a computer 20, a VR headset 25 operably coupled to the computer 20, and sensor(s) 30 also operably coupled to the computer 20. The training rig 35 is an optional portion of the system 10 and generally includes features similar to the piece of equipment for which the user is receiving training. As illustrated, the training rig 35 may include a frame 35a, a seat 35b, a steering wheel 35c that is or includes a steering sensor, a brake pedal 35d that is or includes a brake sensor, and a gas pedal 35e that is or includes a throttle control/sensor, with all of the sensors being wired or otherwise connected to an analog-to-USB interface card that also forms a portion of the training rig 35. However, the features of the training rig 35 may be altered and changed depending on the type of equipment that is the subject of training. While the computer 20 is illustrated as a separate component from the VR headset 25 and the training rig 35 in FIG. 1, in some embodiments the computer 20 is not a stand-alone component of the system 10. Instead, the computer 20 is or forms a portion of the training rig 35 and the VR headset 25 connects directly to the training rig 35 via the USB interface. Alternatively, the VR headset 25 is or forms the computer 20 and the VR headset 25 connects to the USB interface of the training rig 35. In other embodiments, the application 15 is stored in the “cloud” or a remote server and the training application 15 is connected to the VR headset 25 via a network such as the internet such that a PC computer is not required to be present or physically connected to the VR headset 25.

Regarding the training application 15, in some embodiments, the application 15 includes and/or executes one or more web-based programs, Intranet-based programs, and/or any combination thereof. In an example embodiment, the application 15 includes a computer program including a plurality of instructions, data, and/or any combination thereof. In an example embodiment, the application is written in, for example, C#, C++, UnityScript, JavaScript, Python, and/or any combination thereof. In an example embodiment, the application 15 is a web-based application written in, for example, Java or Adobe Flex, which pulls real-time information from the sensor(s) 30, the training rig 35, and/or the VR headset 25.

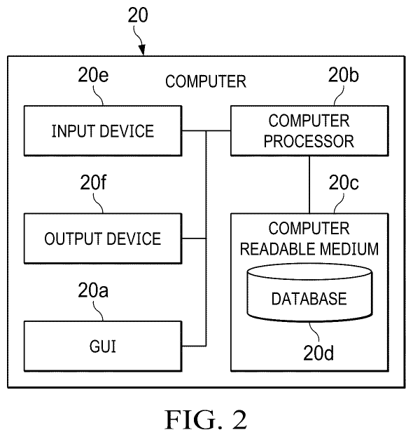

Regarding the computer 20, as illustrated in FIG. 2, one embodiment of the computer 20 includes a GUI 20a, computer processor 20b and a computer readable medium 20c operably coupled thereto. Instructions accessible to, and executable by, the computer processor 20b are stored on the computer readable medium 20c. A database 20d is also stored in the computer readable medium 20c. Generally, the GUI 20a can display a plurality of windows or screens to the user. The computer 20 also includes an input device 20e and an output device 20f. In some embodiments, the input device 20e and the output device 20f are the GUI 20a. In some embodiments, a user provides inputs to the system 10 via the sensors 30. However, the input device 20e can also be a microphone in some embodiments and the output device 20f is a speaker. In several example embodiments, the computer 20 is, or includes, a telephone, a personal computer, a personal digital assistant, a cellular telephone or mobile phone, other types of telecommunications devices, other types of computing devices, and/or any combination thereof. In several example embodiments, the computer 20 includes a plurality of remote user devices.

Regarding the VR headset 25, in some embodiments the VR headset 25 may be an Oculus Rift from Meta Platforms of Irvine, California, HTC VIVE Pro from Dell Technologies of Round Rock, Texas, Lenovo Explorer of Lenovo of Morrisville, North Carolina, Samsung Headset from Samsung of Ridgefield Park, New Jersey. Generally, the VR headset 25 includes one or more of the sensors 30 such as for example motion tracking sensors or an inertial measurement unit (IMU) that can include an accelerometer, a gyroscope, and a magnetometer. Other sensors may include time-of-flight sensors, heat mapping, structured light sensors, bio-sensors, listening/voice recognition sensors, and image/camera sensors. In some embodiments, a camera of the VR headset 25 captures a view of the physical world and displays that view to the user of the VR headset 25.

Regarding the sensor(s) 30, in some embodiments, the sensors 30 include one or more of the sensors of the VR headset 25. In other embodiments, the sensors 30 also include the steering sensor of the training rig 35, the brake sensor of the training rig 35, and the throttle control/sensor of the training rig 35.

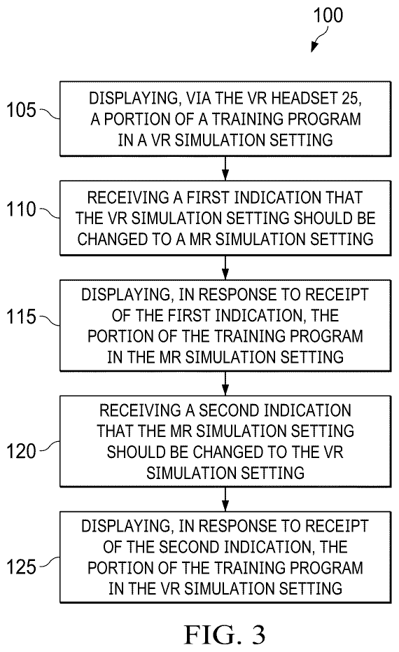

In an example embodiment, as illustrated in FIG. 3 with continuing reference to FIGS. 1-2, a method 100 of operating the system 10 includes displaying, via the VR headset 25, a portion of a training program in a VR simulation setting at step 105; receiving a first indication that the VR simulation setting should be changed from the VR simulation setting to a MR simulation setting at step 110; displaying, in response to receipt of the first indication, the portion of the training program in the MR simulation setting at step 115; receiving a second indication that the MR simulation setting should be changed to the VR simulation setting at step 120; and displaying, in response to receipt of the second indication, the portion of the training program in VR simulation setting at step 125.

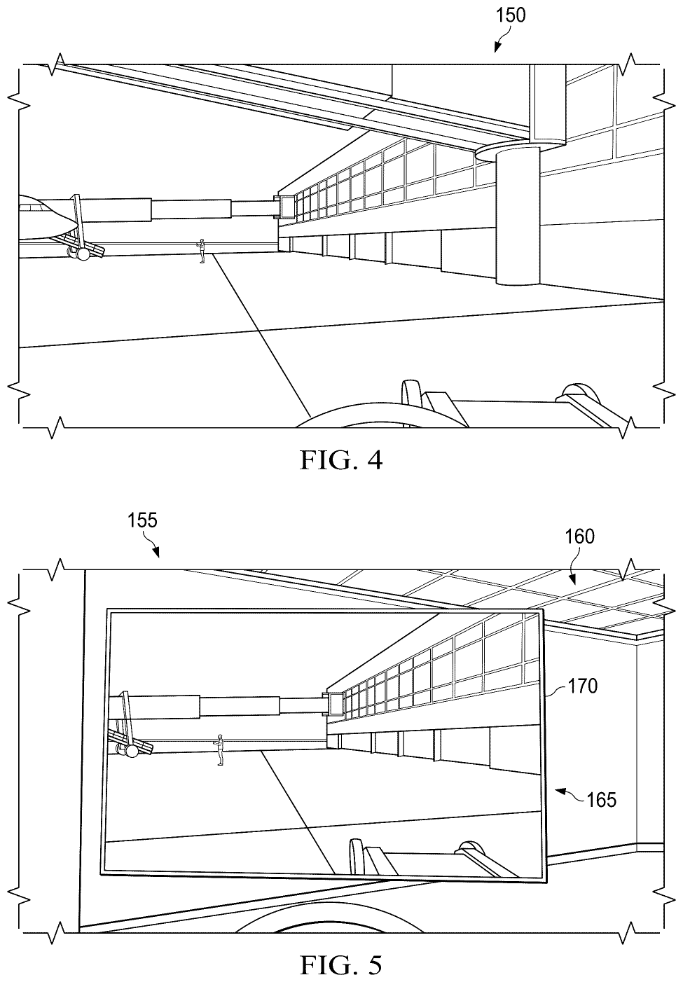

In some embodiments at the step 105, the application 15 displays, via the VR headset 25, a portion of a training program in a VR simulation setting. FIG. 4 provides an illustration 150 of an example of a portion of the training program displayed via the VR headset 25 in a VR simulation setting. Generally, the training program comprises visuals of training objects such as a visual of a jetway, a portion of a terminal, a portion of an aircraft, and a portion of the vehicle that is the subject of training, such as for example a belt loader as illustrated. In some embodiments, the VR simulation setting comprises an immersive 3D environment in which the visuals of training objects appearing in 3D. In some embodiments, the training program includes simulations of lifelike scenarios associated with use of the piece of equipment. One of the lifelike scenarios associated with the use of the piece of equipment comprises driving the piece of equipment in a forward direction and a reverse direction. Generally, the piece of equipment comprises a front and an opposing back, with driving in a forward direction including driving the front end of the piece of equipment forward and driving in reverse includes driving so that the back end leads. The physical representation of the piece of equipment, which is the training rig 35 in this example, is stationary in the physical world.

Generally, while using the VR simulation setting, the system 10 offers unobstructed and complete 3D/360 degree immersion in the targeted environment or lifelike training scenario. This setting or mode, while maximizing realism and offering full depth perception, risks triggering the onset of cybersickness, particularly during hard turns and aggressive driving maneuvers.

In some embodiments at the step 110, the application 15 receives a first indication that the VR simulation setting should be changed from the VR simulation setting to the MR simulation setting. In some embodiments, the first indication that the simulation setting should be changed comprises an input from a user of the training program and/or detection of a condition of the user. In some embodiments, the condition of the user relates to cybersickness and could be measured via user temperature, eye movement, and/or other types of measurements measured by the sensor(s) 30, which includes the sensors in the VR headset 25. The detection of the condition may be detected automatically without user intervention by the system 10 but in other embodiments, the user or administrator provides the first indication via an input device of the system 10.

In some embodiments at the step 115, the application 15 displays, in response to receipt of the first indication, the portion of the training program in the MR simulation setting. The MR simulation setting comprises displaying, over a view of the physical world, a virtual overlay. In some embodiments, the virtual overlay comprises a virtual screen displaying the visuals of training objects. FIG. 5 is an illustration 155 of an example view of the physical world 160 with an overlay 165 that is viewable by the user. As illustrated here, the overlay 165 includes a virtual screen 170. In some embodiments, the virtual screen 170 may be displayed as a 3D object, such as a 3D monitor, 3D TV screen or the like. Displayed on or via the virtual screen 170 are visuals of training objects, which may be displayed in 2D and/or 3D.

The system 10 allows the user to switch to the MR simulation setting, which in some embodiments is a limited 2D representation of the essential portion of the in-motion generated environment, along with any stationary VR elements needed for vehicle operation, and completed by a VR representation of quiet space, or the MR representation of the user's actual environment. In some embodiments, this reduced immersion level presents much like a simulator created in MR, foregoing the full realism of VR to avoid cybersickness. The system 10 offers extremely useful and powerful MR features that are not possible via normal simulators. Generally, the training program that was previously a VR 3D immersive experience is transitioned to be displayed via the overlay 165.

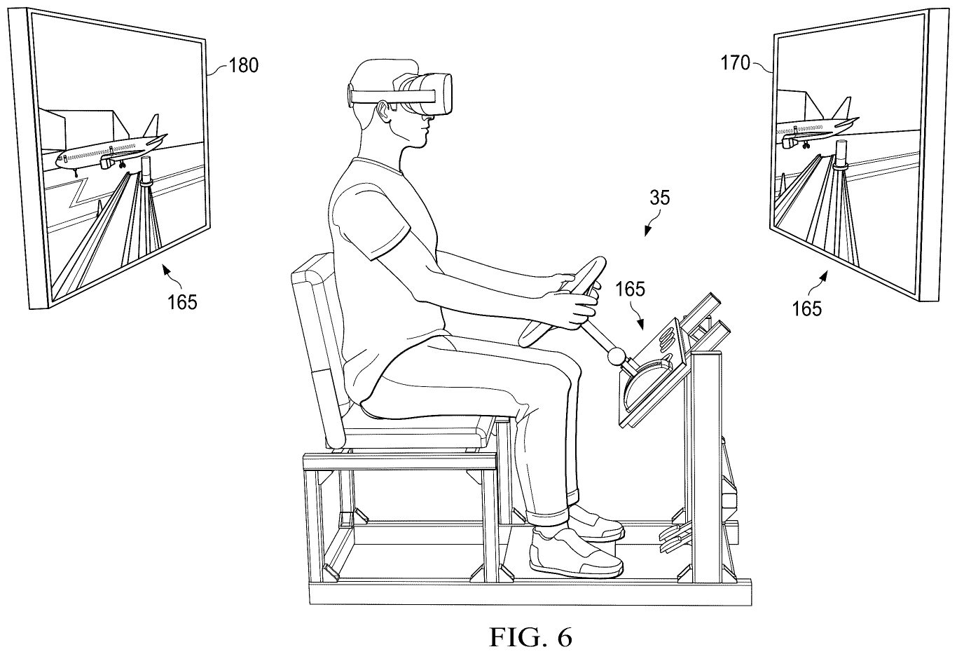

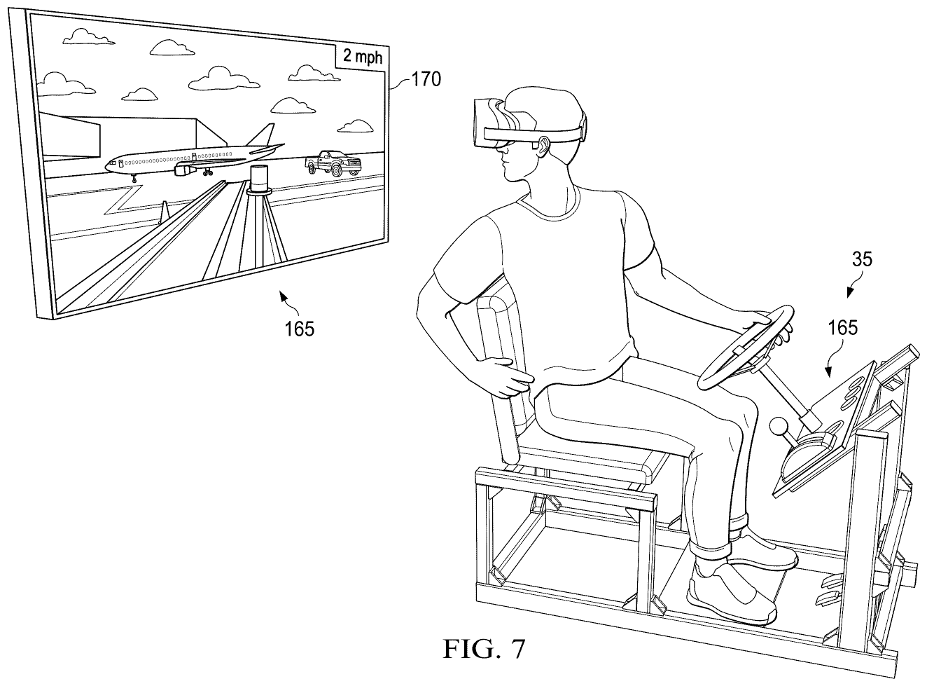

In some embodiments, the overlay 165 includes more than one virtual screen 170. An example of the overlay 165 including more than one virtual screen is illustrated in FIG. 6. As illustrated in FIG. 6, one virtual screen 170 is facing toward the front of the piece of equipment 175 and another virtual screen 180 is facing the back of the training rig 35, which represents the piece of equipment. The physical world environment (i.e., room in which the user and training rig 35 is located) is not illustrated in FIG. 6. The placement of the virtual screen(s) may be dependent upon the lifelike scenario and the input via the sensors 30. For example, when the lifelike scenario associated with the use of the piece of equipment comprises driving the piece of equipment in the forward direction, the virtual screen 170 is positioned facing the front of the piece of equipment. However, the virtual screen 170 may move to face toward the back of the piece of equipment when the lifelike scenario associated with the use of the piece of equipment comprises driving the piece of equipment in the reverse direction. The virtual screen 170 may move from the front to the back, such as when the vehicle is being driven in reverse, in some embodiments, but in others there are two virtual screens 170 and 180 with content that is dependent upon user point-of-view relative to the virtual screens. As illustrated in FIG. 7, a virtual screen facing the back of the vehicle requires the user or trainee to turn and face the rear of the vehicle or training rig 35, an important skill for actual vehicle operation. The physical world environment (i.e., room in which the user and training rig 35 is located) is not illustrated in FIG. 7. As noted, the location, size, and/or shape of the virtual screen(s) 170 relative to the view of the physical world is changeable based on training content of the training program. Generally, this flexibility of virtual screen size/shape/location is not possible with traditional or conventional simulators.

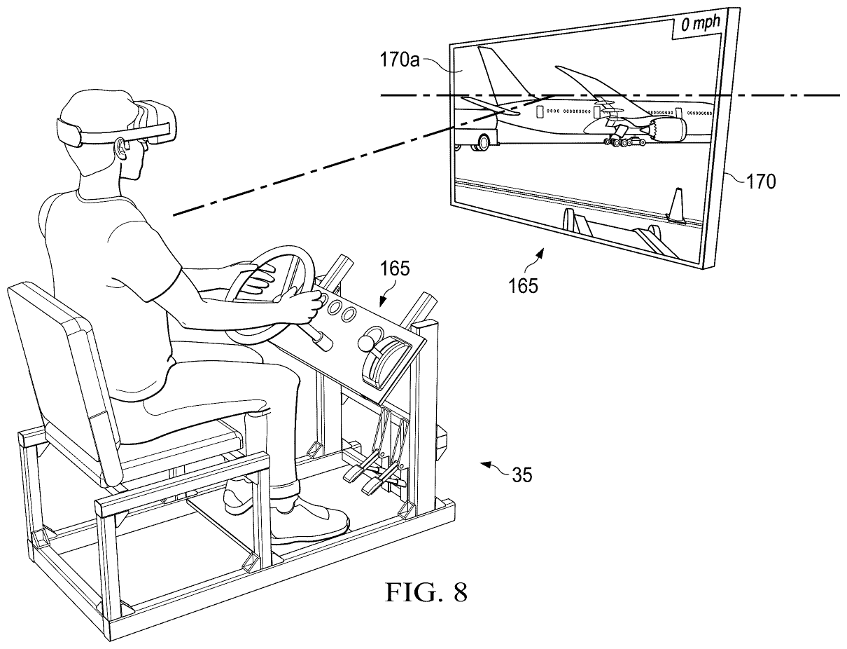

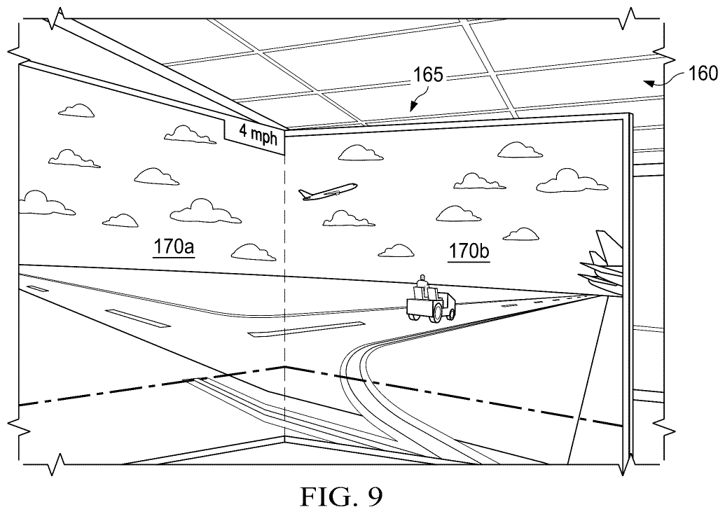

FIGS. 8 and 9 together illustrate an example of the virtual screen 170 changing shape in response to the lifelike scenario displayed by the training application 15. When the lifelike scenario comprises driving the vehicle in a straight direction, as illustrated in FIG. 8, the virtual screen 170 is a first planar surface facing toward the vehicle 175 or the training rig 35. The physical world environment (i.e., room in which the user and training rig 35 is located) is not illustrated in FIG. 8. In some embodiments, the first planar surface is perpendicular to the straight direction and/or perpendicular to the front plane of the training rig 35. When the lifelike scenario comprises turning the vehicle from the straight direction, the virtual screen 170 transforms into a bent 3D screen, as illustrated in FIG. 9. The bent screen comprises the first planar surface 170a and a second planar surface 170b facing substantially perpendicular to first planar surface 170a and positioned near the side of the training rig 35 towards which the vehicle is turning. In the example illustrated in FIG. 9, the user is making a right-hand turn and therefore, the second screen 170b is extending toward the right hand side of the training rig 35. The virtual screens are not limited to be being shaped into a corner or angle as described above. Instead, the virtual screen in some examples is stretched wider—to the left or right—when the vehicle is executing certain activities to broadening the user's field of view. Moreover, the virtual screen may be stretched taller in some embodiments.

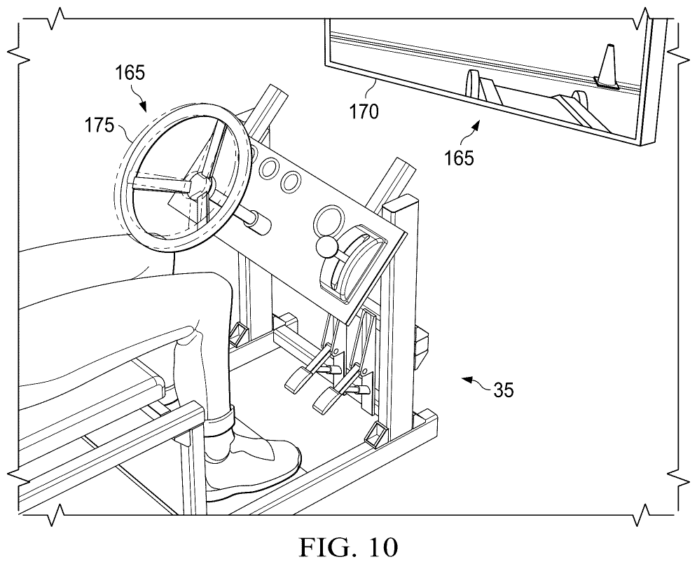

In some examples, the virtual overlay 165 further comprises a virtual representation 175 of the vehicle or at least a portion of the vehicle, as illustrated in FIG. 10. As illustrated in FIG. 10, the virtual representation 175 of the vehicle or the virtual vehicle is shown superimposed over the training rig 35. However, in other embodiments, the training rig 35 is omitted and the user interacts with the virtual representation 175 of the vehicle, and no training rig 35 is needed.

In some embodiments, the virtual representation 175 of the vehicle includes a virtual representation of a virtual rear view mirror and/or one or more virtual side view mirrors. The view visible on the virtual mirror type may correspond to the mirror type (e.g., convex, concave) associated with the vehicle or the default equipment associated with the vehicle. In some embodiments and when the virtual representation 175 of the vehicle includes a virtual mirror, the virtual mirror displays a view that aligns with the mirror angle/location/position relative to the vehicle. For example, for a virtual rear view mirror mounted to the approximate top middle of a windshield that defines a first plane and the virtual rear view mirror is positioned at first angle in a first dimension relative to the first plane and positioned at a second angle in a second dimension relative to the first plane, then the view visible on the virtual rear view mirror will be the view captured by the first angle and the second angle.

In some embodiments at the step 120, the application 15 receives a second indication that the MR simulation setting should be changed to the VR simulation setting. Receiving the second indication is substantially identical to receiving the first indication except that the indication is to switch from MR to VR instead of switching from VR to MR.

In some embodiments at the step 125, the application 15 displays, in response to receipt of the second indication, the portion of the training program in the VR simulation setting. Switching from MR to VR includes transitioning the training program and visual objects from being displayed on the virtual screen(s) to being displayed in 3D to simulate an immersive 3D experience.

Experiments have found that use of the system 10 including switching between VR and MR immediately begins alleviating any growing symptoms of VR cybersickness. While in the MR simulation setting, symptoms can dissipate as the simulation continues. As symptoms lessen and the user feels comfortable to do so, the user can revert to VR simulation setting, and continue to switch back and forth at will to complete the simulation. This approach, over the longer term, may also help desensitize users and reduce overall VR motion sensitivity.

In some embodiments, the system 10 includes multiple VR headsets for multiple users and users are capable of interacting and working together virtually from any location. In other embodiments, each user is associated with a system 10 and the systems are connected via a network. When multiple users are using the system(s) 10, the training program displays the users virtually in one virtual location.

In an example embodiment, the network includes the Internet, one or more local area networks, one or more wide area networks, one or more cellular networks, one or more wireless networks, one or more voice networks, one or more data networks, one or more communication systems, and/or any combination thereof. In some embodiments, the network also includes WIFI, Bluetooth, and Long-Term Evolution (“LTE”) or other wireless broadband communication technology.

The system 10 and/or the method 100 is not limited to training for a vehicle that is driven or moves. Instead, the system and/or method 100 has broad applicability preventing or managing VR cybersickness in multiple applications. Other example uses includes training of aircraft inspection, familiarization, and walkaround; cockpit and cabin familiarization and inspection; and aircraft marshalling. For example, the system 10 and/or method 100 may be used for gaming, social interaction simulations, learning that is not specific to training, and/or treatment or management of VR motion sensitivity generally. For example, the system 10 can be used to display lifelike scenarios that include different conditions, such as a ramp on a rainy night. The disclosed system and method are not limited to training programs and instead can be applied to any variety of VR games (e.g., those that involve first person fast-motion action games like racing or flying) or VR content. This would allow for a larger pool of potential users and longer game play.

In some embodiments, the piece of equipment interacts with another object and the training relates to the interaction between the piece of equipment and the another object. Examples of pieces of equipment and objects include a belt loader interacting (e.g., approaching) an aircraft. Other types of equipment might interact via engaging and disengaging or performing an action on the object). Examples including de-icing equipment de-icing an aircraft. Other examples and associated objects include: a tow tug with or without a certain number of carts in tow; a pushback tug (with towbar or towbarless) with aircraft; a belt loader (diesel, gas, electric) with aircraft; a provisional van with aircraft; a provisioning truck with aircraft; a motorized airstair with aircraft; a motorized boarding bridge with aircraft; an electric pallet jack; a cargo chugger; a utility task vehicles (“UTVs”); and de-icing equipment and aircraft.

Example vehicles or pieces of equipment may include but are not limited to: an automobile; a commercial truck; a bus; a taxi; construction equipment such as for example a crane; a forklift; an ambulance or other medical transportation vehicle; a tractor; an aircraft with the trainee a flight attendant; a train; a subway or other light rail vehicle; an aircraft with the trainee a pilot; a ship, boat or other vessel; a tow truck; a crane; a helicopter with the trainee a pilot; a garbage truck; a fire truck; a delivery vehicle; a glider; a paraglider; a hovercraft; an amphibious vehicle; a jet pack, rocket pack, or flight pack. In some embodiments, the system 10 and/or the method 100 is an immersive program with the piece of equipment being an automobile such that the user of the system 10 and/or the method 100 practices or learns how to drive an automobile.

Unlike a simulator with fixed displays, which is associated with conventional simulators, the virtual screen 165 is virtual and dynamic. As described, multiple screens can be repositioned and resized at any time to ensure the most relevant areas are displayed to maximize objectives like training accuracy and realism.

The system 10 and/or the method 100 also solves a problem relating to the technical field of simulation training because the system and/or the method 100 in part because the system 10 and/or the method 100 is capable of being implemented using portable VR standalone headsets. The system 10 is configured to use the VR headset 25, which compared to conventional systems, results in a system that requires fewer resources and simpler devices. Not only does the system 10 require simpler devices, but the system 10 is mobile or intended to be portable/mobile and offers a more flexible experience for the user, in terms of screen location(s) and sensitivity to VR cybersickness.

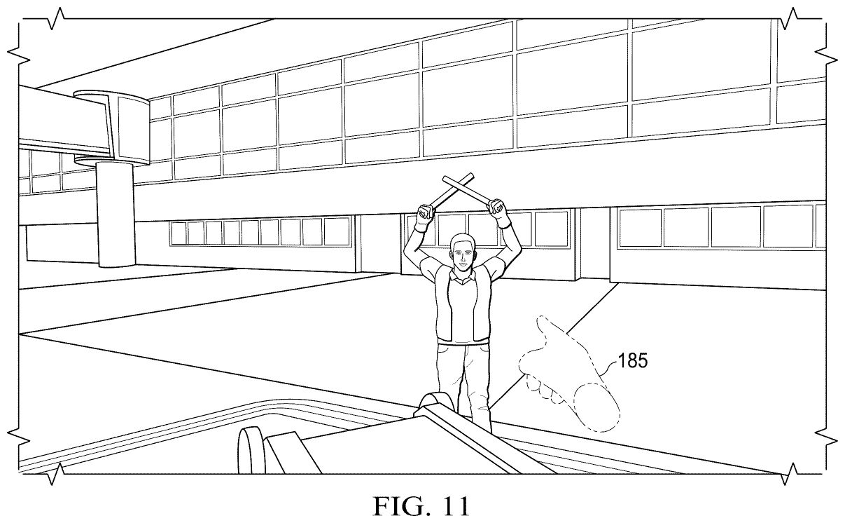

The system 10 and/or the method 100 also improves the technical field of simulation training because the system 10 and/or the method integrates controllerless hand and foot tracking via hardware-based driving input components, such as the physical steering wheel, the accelerator/brake pedal/clutch, along with an optional frame and seat of the training rig 35. These low-cost input devices allow realistic vehicle operational skills that are not possible when using off-the-shelf MR standalone hardware. Moreover, and as illustrated in FIG. 11, the VR headset 25 detects movement of the user's hand in the real world and can display a virtual hand 185 in the VR simulation setting. Thus, in some embodiments, the VR headset 25 includes hand-tracking capabilities. In some embodiments, the hand-tracking capabilities of the VR headset 25 and the system 10 are used in combination with the training program to provide user inputs. For example the user's hand movements in the physical world can be detected relative to a displayed virtual object and the user's hand movements can be inputs as to whether the user pushes a virtual button, moving a virtual switch, etc. so that the training provided via the system 10 can also be extended to activities beyond driving.

The system 10 and/or the method 100 also improves the technical field of simulation training because the alignment of a mechanical vehicle input system (e.g., the training rig 35) with a virtual vehicle input system maximizes training realism and allows a single physical input system to represent multiple vehicles.

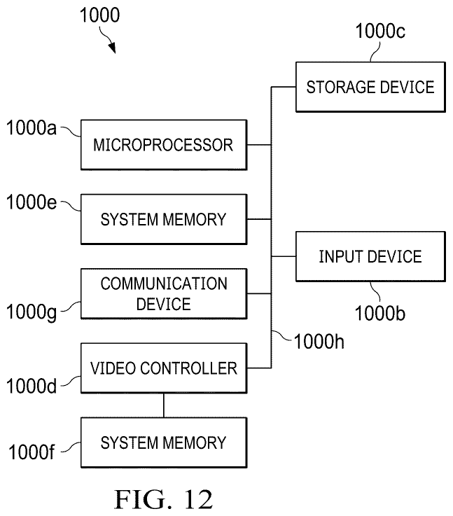

In an example embodiment, as illustrated in FIG. 12 with continuing reference to FIGS. 1-11, an illustrative node 1000 for implementing one or more of the example embodiments described above and/or illustrated in FIGS. 1-11 is depicted. The node 1000 includes a microprocessor 1000a, an input device 1000b, a storage device 1000c, a video controller 1000d, a system memory 1000e, a display 1000f, and a communication device 1000g all interconnected by one or more buses 1000h. In several example embodiments, the storage device 1000c may include a floppy drive, hard drive, CD-ROM, optical drive, any other form of storage device and/or any combination thereof. In several example embodiments, the storage device 1000c may include, and/or be capable of receiving, a floppy disk, CD-ROM, DVD-ROM, or any other form of computer-readable medium that may contain executable instructions. In several example embodiments, the communication device 1000g may include a modem, network card, or any other device to enable the node to communicate with other nodes. In several example embodiments, any node represents a plurality of interconnected (whether by intranet or Internet) computer systems, including without limitation, personal computers, mainframes, PDAS, smartphones and cell phones.

In several example embodiments, one or more of the components of the systems described above and/or illustrated in FIGS. 1-11 include at least the node 1000 and/or components thereof, and/or one or more nodes that are substantially similar to the node 1000 and/or components thereof. In several example embodiments, one or more of the above-described components of the node 1000, the system 10, and/or the example embodiments described above and/or illustrated in FIGS. 1-11 include respective pluralities of same components.

In several example embodiments, one or more of the applications, systems, and application programs described above and/or illustrated in FIGS. 1-11 include a computer program that includes a plurality of instructions, data, and/or any combination thereof; an application written in, for example, Arena, HyperText Markup Language (HTML), Cascading Style Sheets (CSS), JavaScript, Extensible Markup Language (XML), asynchronous Javascript and XML (Ajax), and/or any combination thereof; a web-based application written in, for example, Java or Adobe Flex, which in several example embodiments pulls real-time information from one or more servers, automatically refreshing with latest information at a predetermined time increment; or any combination thereof.

In several example embodiments, a computer system typically includes at least hardware capable of executing machine readable instructions, as well as the software for executing acts (typically machine-readable instructions) that produce a desired result. In several example embodiments, a computer system may include hybrids of hardware and software, as well as computer sub-systems.

In several example embodiments, hardware generally includes at least processor-capable platforms, such as client-machines (also known as personal computers or servers), and hand-held processing devices (such as smart phones, tablet computers, personal digital assistants (PDAs), or personal computing devices (PCDs), for example). In several example embodiments, hardware may include any physical device that is capable of storing machine-readable instructions, such as memory or other data storage devices. In several example embodiments, other forms of hardware include hardware sub-systems, including transfer devices such as modems, modem cards, ports, and port cards, for example.

In several example embodiments, software includes any machine code stored in any memory medium, such as RAM or ROM, and machine code stored on other devices (such as floppy disks, flash memory, or a CD ROM, for example). In several example embodiments, software may include source or object code. In several example embodiments, software encompasses any set of instructions capable of being executed on a node such as, for example, on a client machine or server.

In several example embodiments, combinations of software and hardware could also be used for providing enhanced functionality and performance for certain embodiments of the present disclosure. In an example embodiment, software functions may be directly manufactured into a silicon chip. Accordingly, it should be understood that combinations of hardware and software are also included within the definition of a computer system and are thus envisioned by the present disclosure as possible equivalent structures and equivalent methods.

In several example embodiments, computer readable mediums include, for example, passive data storage, such as a random access memory (RAM) as well as semi-permanent data storage such as a compact disk read only memory (CD-ROM). One or more example embodiments of the present disclosure may be embodied in the RAM of a computer to transform a standard computer into a new specific computing machine. In several example embodiments, data structures are defined organizations of data that may enable an embodiment of the present disclosure. In an example embodiment, a data structure may provide an organization of data, or an organization of executable code.

In several example embodiments, any networks and/or one or more portions thereof may be designed to work on any specific architecture. In an example embodiment, one or more portions of any networks may be executed on a single computer, local area networks, client-server networks, wide area networks, internets, hand-held and other portable and wireless devices and networks.

In several example embodiments, a database may be any standard or proprietary database software. In several example embodiments, the database may have fields, records, data, and other database elements that may be associated through database specific software. In several example embodiments, data may be mapped. In several example embodiments, mapping is the process of associating one data entry with another data entry. In an example embodiment, the data contained in the location of a character file can be mapped to a field in a second table. In several example embodiments, the physical location of the database is not limiting, and the database may be distributed. In an example embodiment, the database may exist remotely from the server, and run on a separate platform. In an example embodiment, the database may be accessible across the Internet. In several example embodiments, more than one database may be implemented.

In several example embodiments, a plurality of instructions stored on a non-transitory computer readable medium having stored thereon a plurality of instructions computer readable medium may be executed by one or more processors to cause the one or more processors to carry out or implement in whole or in part the above-described operation of each of the above-described example embodiments of the system, the method, and/or any combination thereof. In several example embodiments, such a processor may include one or more of the microprocessor 1000a, any processor(s) that are part of the components of the system, and/or any combination thereof, and such a computer readable medium may be distributed among one or more components of the system. In several example embodiments, such a processor may execute the plurality of instructions in connection with a virtual computer system. In several example embodiments, such a plurality of instructions may communicate directly with the one or more processors, and/or may interact with one or more operating systems, middleware, firmware, other applications, and/or any combination thereof, to cause the one or more processors to execute the instructions.

It is understood that variations may be made in the foregoing without departing from the scope of the present disclosure. For example, instead of, or in addition to transportation transactions often conducted in the course of airline industry business, aspects of the present disclosure are applicable and/or readily adaptable to transportation transactions conducted in other industries, including rail, bus, cruise and other travel or shipping industries, rental car industries, hotels and other hospitality industries, entertainment industries, and other industries.

The present disclosure introduces a system configured to display an immersive program, the system comprising a non-transitory computer readable medium having stored thereon a plurality of instructions, wherein the instructions are executed with one or more processors so that the following steps are executed: displaying, via a virtual reality (“VR”) headset, a portion of the immersive program in a VR simulation setting; wherein the immersive program comprises visuals of objects; and wherein the VR simulation setting comprises an immersive 3D environment in which the visuals of objects appear in 3D; receiving a first indication that the VR simulation setting should be changed from the VR simulation setting to a mixed reality (“MR”) simulation setting; and displaying, in response to receipt of the first indication, the portion of the immersive program in MR setting; wherein the VR headset is positioned in a physical world; wherein the MR simulation setting comprises displaying, over a view of the physical world, a virtual overlay; and wherein the virtual overlay comprises a virtual screen displaying the visuals of objects. In some embodiments, the instructions are executed with the one or more processors so that the following steps are also executed: receiving a second indication that the MR simulation setting should be changed from the MR simulation setting to the VR simulation setting; and displaying, in response to receipt of the first indication, the portion of the immersive program in VR setting. In some embodiments, the first indication that the simulation setting should be changed comprises: an input from a user of the immersive program; or detection of a condition of the user. In some embodiments, the virtual overlay comprises the virtual screen displaying the visuals of objects in 2D. In some embodiments, the virtual overlay comprises the virtual screen displaying the visuals of objects in 3D. In some embodiments, the system also includes a physical representation of a piece of equipment; wherein the immersive program includes simulations of lifelike scenarios associated with use of the piece of equipment; wherein the piece of equipment comprises a front and an opposing back; wherein a lifelike scenario associated with the use of the piece of equipment comprises driving the piece of equipment in a forward direction and a reverse direction; wherein the physical representation of the piece of equipment is stationary in the physical world; and wherein, when the portion of the immersive program is displayed in the MR setting: the virtual screen is facing toward the front of the piece of equipment when the lifelike scenario associated with the use of the piece of equipment comprises driving the piece of equipment in the forward direction; and the virtual screen is facing toward the back of the piece of equipment when the lifelike scenario associated with the use of the piece of equipment comprises driving the piece of equipment in the reverse direction. In some embodiments, a location of the virtual screen relative to the view of the physical world is movable based on content of the immersive program. In some embodiments, the immersive program is a training program; wherein the training program includes simulations of lifelike scenarios; and wherein the virtual screen has a size that changes based on the lifelike scenario displayed by the training program. In some embodiments, the immersive program is a training program; wherein the training program includes simulations of lifelike scenarios; and wherein the virtual screen has a shape that changes based on the lifelike scenario displayed by the training program. In some embodiments, the virtual screen is a monitor displayed in 3D. In some embodiments, the monitor displayed in 3D comprises a bent, folded, or curved monitor. In some embodiments, the immersive program includes simulations of lifelike scenarios associated with use of a vehicle; wherein a lifelike scenario associated with the use of the vehicle comprises driving the vehicle in a straight direction or turning the vehicle from the straight direction; wherein, when the portion of the immersive program is displayed in the MR setting, and: when the lifelike scenario associated comprises driving the vehicle in the straight direction, the virtual screen is a first planar surface facing toward the vehicle and extending perpendicular to the straight direction; and when the lifelike scenario associated with the use of the piece of equipment comprises turning the vehicle from the straight direction, the virtual screen comprises a bent 3D screen comprising the first planar surface and a second planar surface facing substantially perpendicular to first planar surface and positioned near the side of the vehicle toward which the vehicle is turning. In some embodiments, the immersive program includes simulations of lifelike scenarios associated with use of a vehicle; and wherein, when the portion of the immersive program is displayed in the MR setting, the virtual overlay further comprises a virtual representation of the vehicle.

The present disclosure also introduces a method comprising: displaying, via a virtual reality (“VR”) headset, a portion of an immersive program in a VR simulation setting; wherein the immersive program comprises visuals of objects; and wherein the VR simulation setting comprises an immersive 3D environment in which the visuals of objects appear in 3D; receiving a first indication that the VR simulation setting should be changed from the VR simulation setting to a mixed reality (“MR”) simulation setting; and displaying, in response to receipt of the first indication, the portion of the immersive program in MR setting; wherein the VR headset is positioned in a physical world; wherein the MR simulation comprises displaying, over a view of the physical world, a virtual overlay; and wherein the virtual overlay comprises a virtual screen displaying the visuals of objects. In some embodiments, the virtual overlay comprises the virtual screen displaying the visuals of objects in 2D. In some embodiments, the virtual overlay comprises the virtual screen displaying the visuals of objects in 3D. In some embodiments, a location of the virtual screen relative to the view of the physical world is movable based on content of the immersive program. In some embodiments, the immersive program is a training program; wherein the training program includes simulations of lifelike scenarios; and wherein the virtual screen has a size that changes based on the lifelike scenario displayed by the training program; and wherein the virtual screen has a shape that changes based on the lifelike scenario displayed by the training program. In some embodiments, the virtual screen is a monitor displayed in 3D; and wherein the monitor displayed in 3D comprises a bent, folded, or curved monitor. In some embodiments, the immersive program includes simulations of lifelike scenarios associated with use of a vehicle; wherein a lifelike scenario associated with the use of the vehicle comprises driving the vehicle in a straight direction or turning the vehicle from the straight direction; wherein, when the portion of the immersive program is displayed in the MR setting, and: when the lifelike scenario associated comprises driving the vehicle in the straight direction, the virtual screen is a first planar surface facing toward the vehicle and extending perpendicular to the straight direction; and when the lifelike scenario associated with the use of the piece of equipment comprises turning the vehicle from the straight direction, the virtual screen comprises a bent 3D screen comprising the first planar surface and a second planar surface facing substantially perpendicular to first planar surface and positioned near the side of the vehicle toward which the vehicle is turning.

One or more of the example embodiments disclosed above and below may be combined in whole or in part with any one or more of the other example embodiments described above and below.

In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several example embodiments, while different steps, processes, and procedures are described as appearing as distinct acts, one or more of the steps, one or more of the processes, and/or one or more of the procedures may also be performed in different orders, simultaneously, and/or sequentially. In several example embodiments, the steps, processes and/or procedures may be merged into one or more steps, processes, and/or procedures.

In several example embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

The phrase “at least one of A and B” should be understood to mean “A; B; or both A and B.” The phrase “one or more of the following: A, B, and C” should be understood to mean “A; B; C; A and B; B and C; A and C; or all three of A, B, and C.” The phrase “one or more of A, B, and C” should be understood to mean “A; B; C; A and B; B and C; A and C; or all three of A, B, and C.”

Although several example embodiments have been described in detail above, the embodiments described are examples only and are not limiting, and those skilled in the art will readily appreciate that many other modifications, changes, and/or substitutions are possible in the example embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A system configured to display an immersive program, the system comprising a non-transitory computer readable medium having stored thereon a plurality of instructions, wherein the instructions are executed with one or more processors so that the following steps are executed:
displaying, via a virtual reality (“VR”) headset, a portion of the immersive program
in a VR simulation setting;
wherein the immersive program comprises visuals of objects; and
wherein the VR simulation setting comprises an immersive 3D environment in which the visuals of objects appear in 3D;
receiving a first indication that the VR simulation setting should be changed from the VR simulation setting to a mixed reality (“MR”) simulation setting; and
displaying, in response to receipt of the first indication, the portion of the immersive program in MR setting;
wherein the VR headset is positioned in a physical world;
wherein the MR simulation setting comprises displaying, over a view of the physical world, a virtual overlay; and
wherein the virtual overlay comprises a virtual screen displaying the visuals of objects.

2. The system of claim 1, wherein the instructions are executed with the one or more processors so that the following steps are also executed:
receiving a second indication that the MR simulation setting should be changed from the MR simulation setting to the VR simulation setting; and
displaying, in response to receipt of the first indication, the portion of the immersive program in VR setting.

3. The system of claim 1, wherein the first indication that the simulation setting should be changed comprises:
an input from a user of the immersive program; or
detection of a condition of the user.

4. The system of claim 1, wherein the virtual overlay comprises the virtual screen displaying the visuals of objects in 2D.

5. The system of claim 1, wherein the virtual overlay comprises the virtual screen displaying the visuals of objects in 3D.

6. The system of claim 1, further comprising a physical representation of a piece of equipment;
wherein the immersive program includes simulations of lifelike scenarios associated with use of the piece of equipment;
wherein the piece of equipment comprises a front and an opposing back;
wherein a lifelike scenario associated with the use of the piece of equipment comprises driving the piece of equipment in a forward direction and a reverse direction;
wherein the physical representation of the piece of equipment is stationary in the physical world; and
wherein, when the portion of the immersive program is displayed in the MR setting:
the virtual screen is facing toward the front of the piece of equipment when the lifelike scenario associated with the use of the piece of equipment comprises driving the piece of equipment in the forward direction; and
the virtual screen is facing toward the back of the piece of equipment when the lifelike scenario associated with the use of the piece of equipment comprises driving the piece of equipment in the reverse direction.

7. The system of claim 1, wherein a location of the virtual screen relative to the view of the physical world is movable based on content of the immersive program.

8. The system of claim 1,
wherein the immersive program is a training program;
wherein the training program includes simulations of lifelike scenarios; and
wherein the virtual screen has a size that changes based on the lifelike scenario displayed by the training program.

9. The system of claim 1,
wherein the immersive program is a training program;
wherein the training program includes simulations of lifelike scenarios; and
wherein the virtual screen has a shape that changes based on the lifelike scenario displayed by the training program.

10. The system of claim 1, wherein the virtual screen is a monitor displayed in 3D.

11. The system of claim 10, wherein the monitor displayed in 3D comprises a bent, folded, or curved monitor.

12. The system of claim 1,
wherein the immersive program includes simulations of lifelike scenarios associated with use of a vehicle;
wherein a lifelike scenario associated with the use of the vehicle comprises driving the vehicle in a straight direction or turning the vehicle from the straight direction;
wherein, when the portion of the immersive program is displayed in the MR setting, and:
when the lifelike scenario associated comprises driving the vehicle in the straight direction, the virtual screen is a first planar surface facing toward the vehicle and extending perpendicular to the straight direction; and
when the lifelike scenario associated with the use of the piece of equipment comprises turning the vehicle from the straight direction, the virtual screen comprises a bent 3D screen comprising the first planar surface and a second planar surface facing substantially perpendicular to first planar surface and positioned near the side of the vehicle toward which the vehicle is turning.

13. The system of claim 1,
wherein the immersive program includes simulations of lifelike scenarios associated with use of a vehicle; and
wherein, when the portion of the immersive program is displayed in the MR setting, the virtual overlay further comprises a virtual representation of the vehicle.

14. A method comprising:
displaying, via a virtual reality (“VR”) headset, a portion of an immersive program in a VR simulation setting;
wherein the immersive program comprises visuals of objects; and
wherein the VR simulation setting comprises an immersive 3D environment in which the visuals of objects appear in 3D;
receiving a first indication that the VR simulation setting should be changed from the VR simulation setting to a mixed reality (“MR”) simulation setting; and
displaying, in response to receipt of the first indication, the portion of the immersive program in MR setting;
wherein the VR headset is positioned in a physical world;
wherein the MR simulation comprises displaying, over a view of the physical world, a virtual overlay; and
wherein the virtual overlay comprises a virtual screen displaying the visuals of objects.

15. The method of claim 14, wherein the virtual overlay comprises the virtual screen displaying the visuals of objects in 2D.

16. The method of claim 14, wherein the virtual overlay comprises the virtual screen displaying the visuals of objects in 3D.

17. The method of claim 14, wherein a location of the virtual screen relative to the view of the physical world is movable based on content of the immersive program.

18. The method of claim 14,
wherein the immersive program is a training program;
wherein the training program includes simulations of lifelike scenarios; and
wherein the virtual screen has a size that changes based on the lifelike scenario displayed by the training program; and
wherein the virtual screen has a shape that changes based on the lifelike scenario displayed by the training program.

19. The method of claim 14,
wherein the virtual screen is a monitor displayed in 3D; and
wherein the monitor displayed in 3D comprises a bent, folded, or curved monitor.

20. The method of claim 14,
wherein the immersive program includes simulations of lifelike scenarios associated with use of a vehicle;
wherein a lifelike scenario associated with the use of the vehicle comprises driving the vehicle in a straight direction or turning the vehicle from the straight direction;
wherein, when the portion of the immersive program is displayed in the MR setting, and:
when the lifelike scenario associated comprises driving the vehicle in the straight direction, the virtual screen is a first planar surface facing toward the vehicle and extending perpendicular to the straight direction; and
when the lifelike scenario associated with the use of the piece of equipment comprises turning the vehicle from the straight direction, the virtual screen comprises a bent 3D screen comprising the first planar surface and a second planar surface facing substantially perpendicular to first planar surface and positioned near the side of the vehicle toward which the vehicle is turning.
